(19) United States
(12) Patent Application Publication
(10) Pub. No.: US 2007/0160812 A1
(43) Pub. Date: Jul. 12, 2007

(54) Products and processes for forming door skins

(76) Inventors: Gregory A. Pickens, Klamath Falls, OR (US); Dennis Richardson, Klamath Falls, OR (US); David Bleha, Klamath Falls, OR (US); Glenn Davina, Klamath Falls, OR (US); Larry M. Maurer, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/374,845

(22) Filed: Mar. 14, 2006

Related U.S. Application Data
(60) Provisional application No. 60/756,899, filed on Jan. 6, 2006.

(51) Int. Cl. B32B 1/00; B28B 5/02; B29C 43/14

(52) U.S. Cl. 428/174; 425/406; 264/294

(57) ABSTRACT

Products and processes for forming door skins. One such process includes forming in a press a master panel having a raised profile extending beyond a planar surface of the master panel. The raised profile can be removed substantially from the master panel to form two distinct panels with each distinct panel having a substantially straight edge. Each door panel can then be sized referencing its substantially straight edge.

### STATEMENT OF RELATED APPLICATIONS

The present application claims priority under 35 U.S.C. §119(e) from U.S. provisional patent application Ser. No. 60/756,899, filed Jan. 6, 2006 entitled, “Products And Processes For Forming Door Skins,” the disclosure of which is hereby incorporated by reference herein in its entirety.

### FIELD OF THE INVENTION

This invention relates generally to products and processes for forming door skins, and more particularly to forming door skins from a door skin master panel.

### BACKGROUND

Door skins may be formulated as wood composites that are molded as thin layers and then secured to an underlying door frame, core, or other support to simulate a solid, natural wood door. Generally, fiberboard door skins are made by combining wood fiber, a resin binder, and a wax, and pressing the mixture under conditions of elevated temperature and pressure to form a thin-layer wood composite. Fiberboard door skins can be economical to manufacture, durable, resistant to damage, and light-weight. Fiberboard door skins further provide an efficient way to incorporate a wide variety of aesthetically-pleasing patterns or profiles into finished doors without requiring intricate routing and other labor-intensive woodworking methods.

To increase manufacturing efficiency and production rates, a multi-opening press may be used to form door skins. Generally, a multi-opening press forms a single master panel, that is, two door skins formed and connected together. In some processes, the master panel may be divided into separate door skins before sizing the individual door skins. Sizing generally refers to trimming door skin edges to precise dimensions before securing the door skin to a door frame. Sizing systems and methods are further described in commonly-owned, co-pending U.S. patent application Ser. No. 11/106,224, entitled, “Systems And Methods Of Identifying And Manipulating Objects,” the disclosure of which is hereby incorporated by reference in its entirety herein.

Dividing or separating master panels prior to sizing may provide flexibility in handling and inventory. There are several known methods of separating master panels into individual door skins. In one known method a scoring bar is disposed between two door skin dies. The scoring bar presses a notch lengthwise in the master panel when the dies are pressed together. The notch can be used as a score line to break the skins in two. A disadvantage of this method is that the break along the scoring line is not straight or uniform, with variances of approximately 0.125 inches (3.175 mm). Such an edge cannot be used as a reference to accurately or properly size a door skin. A door skin using this method can be sized using an embossed profile of the door skin as a reference, which may increase the complexity of sizing such a door skin. Other disadvantages are that this method is not automated and is repetitive in nature.

Another known method of separating a master panel into individual door skins includes using a rolling shear, or alternatively, a saw may be used. Such a method generally includes positioning one rolling shear above the master panel and another rolling shear below the master panel. As the master panel passes through the rolling shears, it is split apart. While this method provides a smoother cut than using a scoring bar (described above), this method typically results in an arched cut along the door skin edges. An arched cut along the door skin edges generally cannot be used as an accurate or reliable reference to properly size a door skin. Such a door skin can be sized using an embossed profile of the door skin as a reference, which may increase the complexity of sizing the door skin.

This method also requires very accurate alignment of the master panel prior to entering the rolling shear. Misalignment may result in product rejects. As a result of the precision required, additional time is needed to properly align the master panels prior to entering the rolling shear, which may result in inefficiencies in high-production environments and in processes using multi-opening presses.

Other processes do not separate the master panels before sizing. However, such processes have several disadvantages. One such disadvantage is that door skins cannot be sized to order. Rather they must be sized based on inventory levels and later re-cut to a smaller size, if needed.

Thus, there is a need for improved products and processes for forming door skins.

### SUMMARY

Embodiments of the present invention comprise products and processes for forming door skins.

One embodiment of the present invention comprises a profiled die element disposed between a first die and a second die and a recessed die element disposed between a third die and a fourth die. The profiled and recessed die elements together are adapted to form in a pressed master panel a raised profile extending substantially along a length of the pressed master panel. The raised profile may be removed substantially, thus forming two distinct panels from the master panel. Panels thus formed may have a substantially straight edge, which may be used as a reference when sizing the panels.

Another embodiment of the present invention comprises forming in a press a master panel having a raised profile extending beyond a planar surface of the master panel. The raised profile is adapted to be removed substantially from the master panel, which forms two distinct panels. Each distinct panel thus formed has a substantially straight edge. The process may further comprise referencing one of the straight edges when sizing one of the distinct panels.

These exemplary embodiments are mentioned not to summarize the invention, but to provide an example of an embodiment to aid understanding. Exemplary embodiments are discussed in the Detailed Description, and further description of the invention is provided there. It is to be understood that the invention is not limited in its application to the specific details as set forth in the following description and figures. The invention is capable of other embodiments and of being practiced or carried out in various ways. Advantages offered by the various embodiments of the present invention may be understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 shows an overview of a known method used to make door skins.

FIG. 2 shows a misaligned prior art master panel.

FIG. 3 shows a cut line for the misaligned prior art master panel shown in FIG. 2.

FIG. 4 shows separated panels of the misaligned prior art master panel of FIG. 2 having been cut along the cut line shown in FIG. 3.

FIG. 5 shows a side view of a master panel formed according to an embodiment of the present invention.

FIG. 6 shows a side view of two separate panels formed from the master panel shown in FIG. 5.

FIG. 7 shows a raised profile of a master panel formed according to an alternate embodiment of the present invention.

FIG. 8 shows a raised profile of a master panel formed according to another alternate embodiment of the present invention.

FIG. 9 shows a raised profile of a master panel formed according to a further alternate embodiment of the present invention.

FIG. 10 shows a raised profile of a master panel formed according to yet another alternate embodiment of the present invention.

FIG. 11 shows a misaligned master panel formed in accordance with an embodiment of the present invention.

FIG. 12 shows the misaligned master panel shown in FIG. 11 superposed on a path of a trim saw.

FIG. 13 shows two separate panels formed from the misaligned master panel shown in FIG. 11.

FIG. 14 shows a schematic representation of an apparatus in accordance with an embodiment of the present invention.

FIG. 15 shows an enlarged detail of the schematic representation shown in FIG. 13.

FIG. 16 shows a block diagram of a method in accordance with an embodiment of the present invention.

FIG. 17 shows a block diagram of a method in accordance with another embodiment of the present invention.

### DETAILED DESCRIPTION

Embodiments of the present invention comprise products and processes for forming door skins. The present invention, however, is not limited to door skins. The principles of the present invention may be applied to other products that are formed using a press, including, for example, cabinet doors, panels, facades.

A fiberboard door skin is a sheet or mat that can be assembled with a door frame comprising rails and stiles to form an assembled door. A fiberboard door skin may comprise, for example, a nominal caliper ranging between about 0.100 inch (2.540 mm) and about 0.130 inch (3.302 mm) molded product using a dry process fiberboard mat initially about one inch (2.540 cm) to about eight inches (20.320 cm) thick. Generally, fiberboard door skins may range in size from about 97 inches (2.464 m) in length by 49 inches (1.245 m) in width to about 60 inches (1.524 m) in length by 9 inches (0.229 m) in width. In an embodiment, a door skin may be sized to fit a door frame of about 36 inches (0.914 m) wide by about 80 inches (2.032 m) long. Still, door skins of other sizes, such as panels of up to about 18 feet (5.486 m) in length may be manufactured using the systems and methods of the present invention.

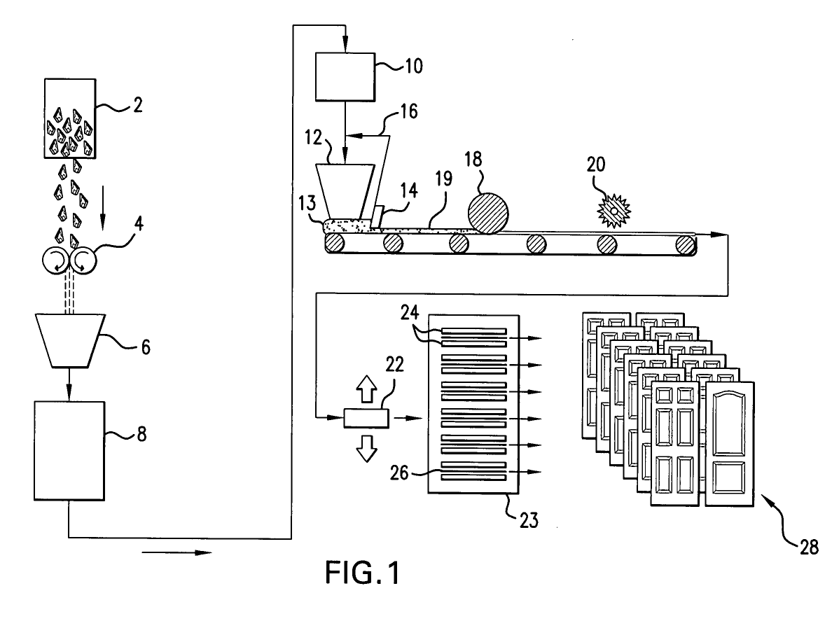

FIG. 1 shows an overview of a known method used to make door skins. As shown in FIG. 1, a source of lignocellulosic fiber, such as a selected wood species 2, may be ground by a refiner 4 to prepare fibers 5 of a substantially uniform size. In one embodiment of the present invention, the selected wood species may comprise hybrid wood poplar. Other suitable species or mixtures of species can be used. Wax may then be added and/or the lignocellulosic fibers may be at least partially dried 6. At this point, the fiber/wax blend may then be mixed with an appropriate binder resin (e.g., using atomization), until a uniform mixture is formed 8 and the preparation may be stored 10 until further processing.

Resin may also be added to the fiber after the fiber storage bin and before the mixture is formed. The composition of resins are described further in commonly owned, co-pending U.S. patent application Ser. No. 10/785,559, entitled, “Thin-Layer Lignocellulose Composites Having Increased Resistance To Moisture And Methods Of Making Same,” filed Feb. 24, 2004, the disclosure of which is hereby incorporated by reference in its entirety herein.

The fiber/resin mixture may then be processed by a former 12 into a loose mat 13. The loose mat 13 may then be pre-shaped using a shave-off roller 14 and pre-compressed using a pre-compressor 18 to mat 19 having a density of about 6 to 15 pounds per cubic foot (96 kg/m³ to 240.277 kg/m³). At this point, the excess mat material removed by the shaver may be recycled back to the former 12. After further trimming to the correct size and shape, as for example, using saw 20, the pre-pressed mats are transferred to a loader 22 to be loaded into a platen press 23. Each mat is compressed between dies 24 under conditions of increased temperature and pressure. For example, standard pressing conditions may comprise pressing at about 290 degrees F. at 1200 psi for 10 seconds followed by 20 seconds at 500 psi (i.e., about 143 degrees C. at 84.3 kg/cm² for 10 seconds followed by 20 seconds at 35.2 kg/cm²).

Generally, a recessed (female) die is used to produce an inner surface of a door skin, and a male die shaped as the mirror image of the female die is used to produce the outside surface of the door skin. Also, the die that forms the side of the door skin that will be the outer surface may include an impression to create a simulated wood grain pattern. After exiting the press 23, master panels 26 are separated and sized forming individual door skins 28.

Methods of making door skins are further described in commonly-owned, co-pending U.S. patent application Ser. Nos. 10/839,639, entitled, “Molded Thin-Layer Lignocellulose Composites Having Reduced Thickness And Methods Of Making Same,” filed May 5, 2004, and Ser. No. 10/856,683, entitled, “Molded Thin-Layer Lignocellulosic Composites Made Using Hybrid Poplar And Methods of Making Same,” filed May 28, 2004, the disclosure of each of which is hereby incorporated by reference in its entirety herein.

As described above, prior art methods of separating master panels into individual door skins include using a rolling shear or saw to cut the master panels. Without precise alignment, such prior art methods can result in rejected door skins. Referring now to FIG. 2, a master panel 30 of the prior art is shown. The master panel 30 includes a first door skin 31 and a second door skin 32. The first door skin 31 and the second door skin 32 are joined together in the master panel 30, and must be separated to form a finished door skin (not shown). To form a finished door skin, the master panel 30 must be cut, or sized, along one or more cut lines, such as the cut line 33. Sizing the master panel 30 is necessitated by the pressing operation, as described above, which forms an uneven perimeter 34 around the master panel 30.

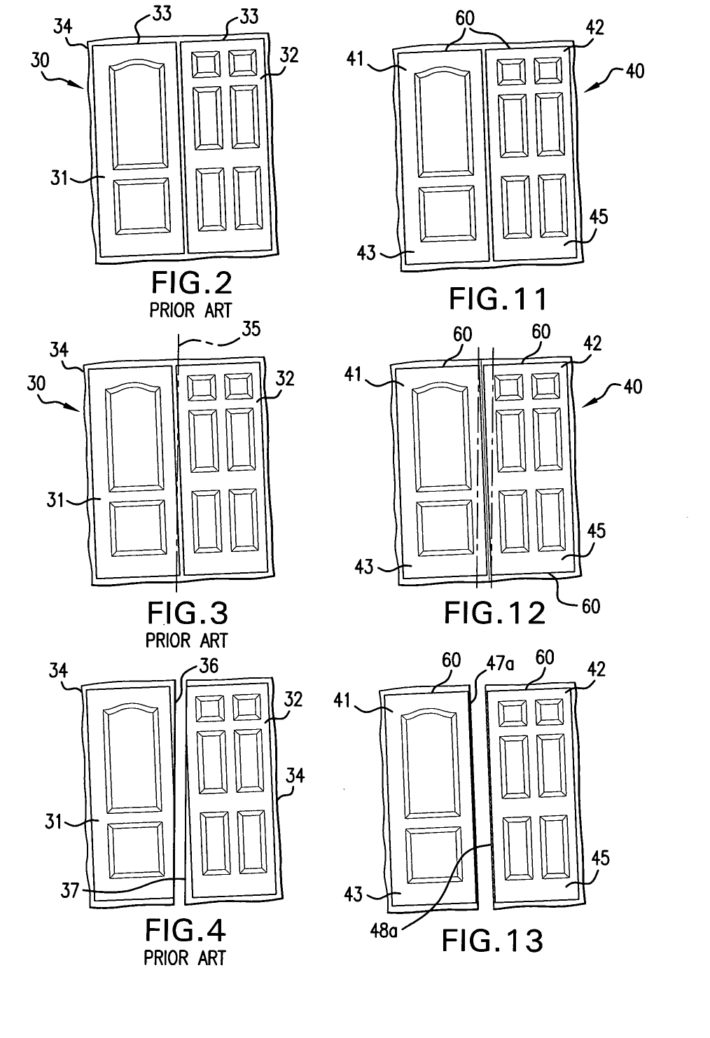

As can be better seen in FIG. 3, the master panel 30 is misaligned with respect to a vertical axis, which can be represented by the cut line 35 of the rolling shear or saw. In one embodiment, the cut line 35 may correspond with the centerline of a properly aligned master panel 30. In other embodiments, however, the cut line 35 does not necessarily correspond with the centerline of the master panel 30.

Referring now to FIG. 4, the first door skin 31 and the second door skin 32 are separated from the misaligned master panel 30 after the master panel 30 was cut by the rolling shear or saw (not shown) along the cut line 35. Cutting the master panel 30 along the cut line 35 forms a first edge 36 of the first door skin 31 and a second edge 37 of the second door skin 32. As can be seen, misalignment of the master panel 30 in the prior art can result in rejected door skins. As shown in FIG. 4, the door skins 31, 32 have been cut beyond and into the finished surfaces of the door skins 31, 32. What can not be seen in FIG. 4, however, is that the first and second edges 36, 37 are arched as a result of the cutting or shearing operation. Arched edges make it difficult, if not impracticable, to use the first and second edges 36, 37 as a reference when sizing the first and second door skins 31, 32.

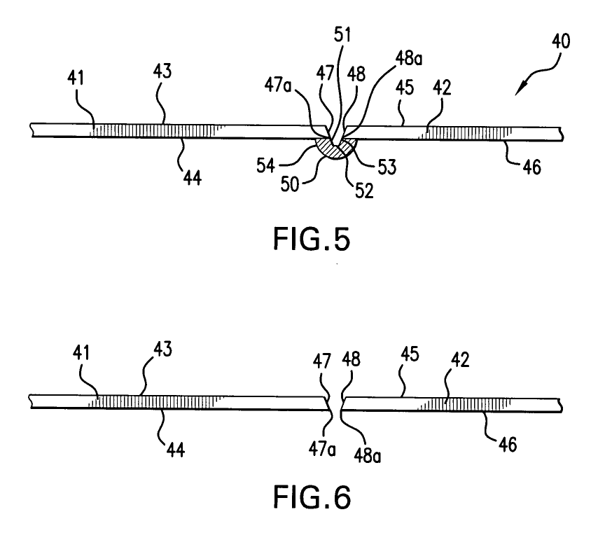

Referring now to FIG. 5, a side view of a master panel 40 formed according to an embodiment of the present invention is shown. Forming the master panel 40 will be described in further detail below. The master panel 40 comprises a pressed fiberboard mat. The composition of the master panel 40 may be similar to that described above. Likewise, the process parameters used to form the master panel 40 may be similar to the process parameters described above. Alternatively, the master panel 40 may be formed of other suitable materials and by other suitable means.

The master panel 40 may comprise a first panel section 41 and a second panel section 42. The first and second panel sections 41, 42 are formed and disposed adjacent to one another. The first and second panel sections 41, 42 may ultimately form finished door skins (not shown) after separation from the master panel 40 and further processing, such as, for example, sizing. Although not shown, the first and second panel sections 41, 42 may include a variety of raised surfaces and profiles to form decorative panels or surfaces. The master panel 40 comprises a first surface 43 and a second surface 44.

The first and second surfaces 43, 44 are disposed in facing opposition to one another, and are generally parallel to one another. With the exception of decorative panels (not shown) formed in the first panel section 41, the first and second surfaces 43, 44 are generally planar surfaces. Disposed between the first and second surfaces 43, 44 is a first end 47 of the first panel section 41. A first edge 47a is formed by an intersection of the first end 47 and the second surface 44. The first edge 47a forms a substantially straight line extending substantially along the length of the master panel 40 and is substantially parallel to a central, vertical (or axial) axis of the master panel 40.

The master panel 40 comprises a third surface 45 and a fourth surface 46. The third surface 45 is substantially coplanar with the first surface 43 and the fourth surface 46 is substantially coplanar with the second surface 44. The third and fourth surfaces 45, 46 are disposed in facing opposition to one another, and are generally parallel to one another. With the exception of the decorative panels (not shown) formed in the second door skin 42, the third and fourth surfaces 45, 46 are generally planar surfaces.

Disposed between the third and fourth surfaces 45, 46 is a second end 48 of the second panel section 42. A second edge 48a is formed by an intersection of the second end 48 and the fourth surface 46. The second edge 48a forms a substantially straight line extending substantially along the length of the master panel 40 and is substantially parallel to the central, vertical (or axial) axis of the master panel 40. The first end 47 and the second end 48 separate the first and second panel sections 41, 42.

A thickness of the first panel section 41 (that is, a distance between the first and second surfaces 43, 44) may be about 0.115 inch (2.921 mm). Similarly, a thickness of the second panel section 42 (that is, a distance between the third and fourth surfaces 45, 46) may be about 0.115 inch (2.921 mm). Alternatively, the thicknesses of the first and second panel sections 41, 42 may range between about 0.100 inch (2.540 mm) and about 0.130 inch (3.302 mm).

Joining the first and second panel sections 41, 42 together, and thus forming the single master panel 40, is a raised profile 50. As will be described below, the raised profile 50 is integrally formed in the master panel 40. The raised profile 50 may be disposed substantially in the center of the master panel 40 between the first and second panel sections 41, 42. The raised profile 50, however, is not necessarily disposed in the center of the master panel 40. The raised profile 50 extends beyond the planar surfaces of the second surface 44 of the first panel section 41 and the fourth surface 46 of the second panel section 42. Although not shown, the raised profile 50 extends substantially along an entire length of the master panel 40.

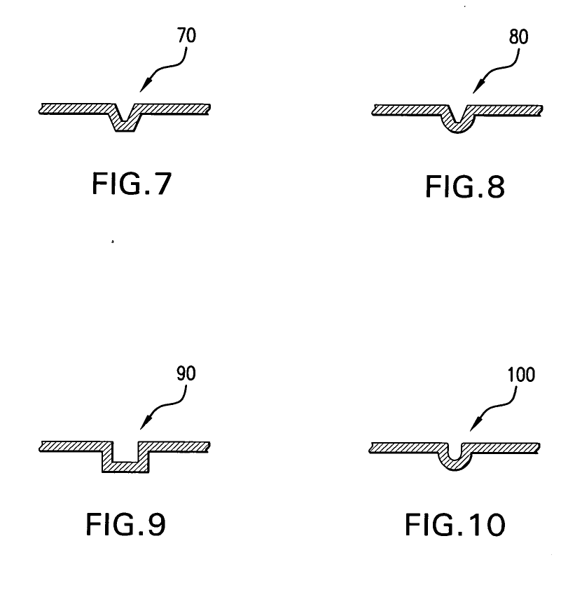

The raised profile 50 may comprise a first wall 51, a second wall 53 opposite the first wall 51, and a closed end 52 joining the first and second walls 51, 53. The closed end 52 may be a substantially planar surface. The first wall 51 may be substantially colinear with the first end 47 of the first panel section 41. Similarly, the second wall 53 may be substantially colinear with the second end 48 of the second panel section 42. A cross-section of the surfaces of the first and second walls 51, 53 and the closed end 52 form a frustum. Examples of other suitable raised profiles 70, 80, 90, 100 (shown in cross-section) are shown in FIGS. 7-10.

The raised profile 50 may comprise a raised surface 54. The raised surface 54 may be substantially semi-cylindrical. As shown in FIGS. 7-10, however, other profiles may be used. A semi-cylindrical shape is generally used for ease of manufacturing. The raised surface 54 forms a perimeter for the raised profile 50. A perpendicular distance between the closed end 52 and the raised surface 54 may be substantially equal to the thickness of the first panel section 41 and the second panel section 42, that is, about 0.115 inch (2.921 mm).

Referring now to FIG. 6, a side view of the first panel section 41 and the second panel section 42 having been separated from the master panel 40 is shown. The raised profile 50 may be removed substantially entirely from the master panel 40. Thus, the first and second panel sections 41, 42 are separate from one another, and are distinct panels. The first and second panel sections 41, 42 can now be inventoried and processed separately from one another.

The portions of the raised profile 50 contacting the second surface 44 of the first panel section 41 and the fourth surface 46 of the second panel section 42 may be removed substantially entirely, thus exposing the first edge 47a and the second edge 48a. The first and second edges 47a, 48a are substantially straight and uniform, and extend along the entire lengths of the first and second panel sections 41, 42, respectively. Thus, the first and second edges 47a, 48a each may be used as a reference when sizing the first and second panel sections 41, 42, respectively.

The raised profile 50 may be removed by a trim saw (not shown), such as a so-called hogger. The master panel 40 may be placed on a chain or belt conveyor (not shown), or other suitable device, leading the master panel 40 to the trim saw. The second surface 44 of the first panel section 41 and the fourth surface 46 of the second panel section 42 face a conveying surface of the conveyor. The master panel 40 may be pressed firmly against the conveying surface of the conveyor and aligned with respect to a central axis of the trim saw. The master panel 40 may be pressed firmly against the conveyor by hold-down rolls, or other suitable devices.

With the master panel 40 pressed firmly against the conveyor, the blades of the trim saw do not project beyond the planar surfaces of the master panel 40, that is, the second surface 44 of the first panel section 41 and the fourth surface 46 of the second panel section 42. Thus, the trim saw may completely remove the raised profile 50 without removing the planar surfaces of the master panel 40.

As a kerf of the trim saw may be about 2.250 inches (5.715 cm) wide, the master panel 40 does not require precise alignment with respect to the trim saw to completely remove the raised profile 50 from the master panel 40. Other suitable dimensions of the kerf saw may be used. The master panel 40 may be out of alignment less than about +/−1.500 inches (3.810 cm) to completely remove the raised profile 50 from the master panel 40.

Referring now to FIGS. 11-13, separating the master panel 40 which has been misaligned with respect to a vertical axis is shown. FIG. 11 shows the master panel 40 misaligned prior to being separated by the trim saw. Cut lines 60 which are used to produce finished door skins (not shown) from the first panel section 41 and the second panel section 42 are shown. FIG. 12 shows the master panel 40 misaligned prior to being separated by the trim saw. Superposed on the master panel 40 is the width of the cutting path, or kerf, of the trim saw (or hogger).

Because the trim saw is positioned such that it removes the raised profile 50 only without removing the planar surfaces of the master panel (that is, the second surface 44 of the first panel section 41 and the fourth surface 46 of the second panel section 42), misalignment of the master panel 40 (and likewise misalignment of the raised profile 50) does not result in rejected skins as would a misalignment of a master panel of the prior art. FIG. 13 shows the distinct first panel section 41 and the second panel section 42 having been separated from the master panel 40.

As only the raised profile 50 has been removed from the master panel 40, the first panel section 41 is separated from the master panel 40 with a substantially straight and uniform first edge 47a. Likewise, the second panel section 42 is separated from the master panel 40 with a substantially straight and uniform second edge 48a. Being substantially straight and uniform, the first edge 47a may be used as a reference when sizing the first panel section 41 and the second edge 48a may be used as a reference when sizing the second panel section 42.

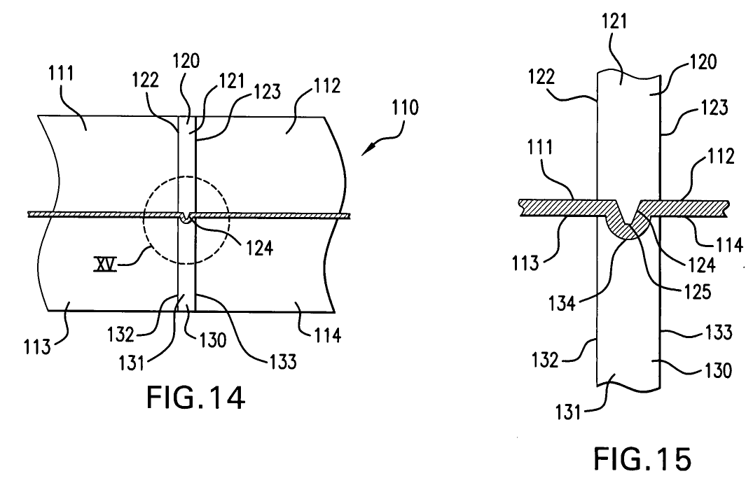

Referring now to FIG. 14, a schematic representation of a press 110 for forming the master panel 40 according to an embodiment of the present invention is shown. FIG. 14 shows an end view of the press 110. The press 110 comprises a first die 111 and a second die 112 disposed proximate to the first die 111. The first and second dies 111, 112 may each comprise a male die. The first and second dies 111, 112 may be substantially similar in all material respects. Alternatively, the first and second dies 111, 112 may each have different die patterns to form different panel designs in a formed door skin.

Interposed between the first and second dies 111, 112 is a profiled die element 120. The profiled die element 120 may comprise a bar and may be coupled to the first and second dies 111, 112. The profiled die element 120 may be fixedly or removably attached to the first and second dies 111, 112. Alternatively, the die element 120 may be integrally formed with the first and second dies 111, 112. A length of the profiled die element 120 may be about 107 inches (271.78 cm). Alternatively, other suitable dimensions may be used. The first and second dies 111, 112 and the profiled die element 120 all move together when the press 110 opens and closes.

The press 110 also comprises a third die 113 and a fourth die 114 disposed proximate to the third die 113. The third and fourth dies 113, 114 may each comprise a female die. The third die 113 is disposed in facing opposition to the first die 111 and the fourth die 114 is disposed in facing opposition to the second die 112. The third die 113 is complementary to the first die 111 and the fourth die 114 is complementary to the second die 112. The third and fourth dies 113, 114 may be substantially similar in all material respects. Alternatively, the third and fourth dies 113, 114 may each have different die patterns to form different panel designs in a formed door skin.

Interposed between the third and fourth dies 113, 114 is a recessed die element 130. The recessed die element 130 may comprise a bar and may be coupled to the third and fourth dies 113, 114. The recessed die element 130 may be fixedly or removably attached to the third and fourth dies 113, 114. Alternatively, the recessed die element 130 may be integrally formed with the third and fourth dies 113, 114. A length of the recessed die element 130 may be substantially the same as the length of the profiled die element. Alternatively, other suitable dimensions may be used. The third and fourth dies 113, 114 and the recessed die element 130 all move together when the press 110 opens and closes.

The recessed die element 130 is disposed in facing opposition to the profiled die element 120. A cross-section of the recessed die element 130 shown in FIG. 14 is semi-circular or semi-cylindrical. Alternatively, other suitable shapes may be used. In an alternate embodiment, the recessed die element 130 is complementary to the profiled die element 120. The first and second dies 111, 112 and the profiled die element 120 together with the third and fourth dies 113, 114 and the recessed die element 130 together are adapted to form a master panel, such as the master panel 40 described above.

Referring now to FIG. 15, detail XV of FIG. 14 is shown. FIG. 15 more clearly shows the profiled die element 120 and the recessed die element 130. The profiled and recessed die elements 120, 130 are shown when the press 110 is in a closed position. When the press 110 is in a closed position, a distance between the first and third dies 111, 113 is about 0.115 inches (2.921 mm). Likewise, a distance between the second and fourth dies 112, 114 is about 0.115 inches (2.921 mm) when the press is in a closed position. Other suitable distances between the dies 111, 113 and 112, 114 may be used.

The profiled die element 120 comprises a body 121, a first lateral surface 122, a second lateral surface 123, and a profiled surface 124. The first and second lateral surfaces 122, 123 are disposed in facing opposition to one another. The first lateral surface 122 is adjacent to the first die 111 and the second lateral surface 123 is adjacent to the second die 112. The first lateral surface 122 may be contiguous with the first die 111 and the second lateral surface 124 may be contiguous with the second die 112.

Interposed between the first and second lateral surfaces 122, 123 is the profiled surface 124. The first and second lateral surfaces 122, 123 and the profiled surface 124 define the body 121. The body 121 may be substantially solid. A width of the body 121 (that is, a distance between the first and second lateral surfaces 122, 123) may be between about 0.375 inches (9.525 mm) to about 0.500 inches (12.700 mm). In one embodiment, the width of the body 121 may be less than about 0.375 inches (9.525 mm).

The profiled surface 124 may form a variety of shapes depending on the shape desired for the raised profile of the master panel. The profiled surface 124 shown in FIGS. 14 and 15 is substantially unshaped with flared sides or legs. The profiled surface 124 may be nickel plated to enhance durability of the profiled die element 120. Alternatively, other suitable materials may be used to plate the profiled surface 124. In another embodiment, the profiled surface 124 is not plated.

The recessed die element 130 comprises a body 131, a third lateral surface 132, a fourth lateral surface 133, and a recessed surface 134. The third and fourth lateral surfaces 132, 133 are disposed in facing opposition to one another. The third lateral surface 132 is adjacent to the third die 113 and the fourth lateral surface 133 is adjacent to the fourth die 114. The third lateral surface 132 may be contiguous with the third die 113 and the fourth lateral surface 134 may be contiguous with the fourth die 114.

Interposed between the third and fourth lateral surfaces 132, 133 is the recessed surface 134. The third and fourth lateral surfaces 132, 133 and the recessed surface 134 define the body 131. The body 131 may be substantially solid. A width of the body 131 may be substantially equal to the width of the body 121 of the profiled die element.

The recessed surface 134 may form a variety of shapes depending on the shape desired for the raised profile of the master panel. The recessed surface 134 shown in FIGS. 14 and 15 is substantially semi-circular or semi-cylindrical. Alternatively, other suitable shapes may be used. A perpendicular distance from a vertex 125 of the profiled surface 124 of the profiled die element 120 to the recessed surface 134 of the recessed die element 130 is about 0.115 inches (2.921 mm), which is substantially the same distance as that between the first and third dies 111, 113 and the second and fourth dies 112, 114 when the press 110 is in a closed position.

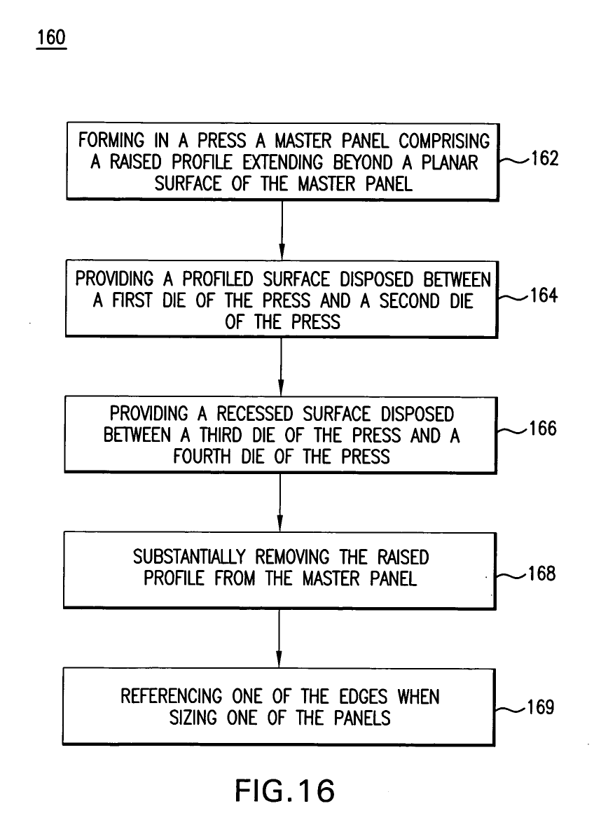

Referring now to FIG. 16, a method 160 according to an embodiment of the present invention is shown. The method 160 may be used to form distinct panels from a master panel according to the present invention. The panels may be similar to that described above. However, the method 160 may be used to form a wide variety of other panels. The panels described above may be referred to in describing the method 160 to aid understanding of the method shown and described.

As indicated by block 162 of FIG. 16, the method 160 may comprise forming in a press a master panel comprising a raised profile extending beyond a planar surface of the master panel. The raised profile is formed integrally with the master panel, and may extend substantially along an entire length of the master panel. In one embodiment, the master panel may be misaligned with respect to a first axis, such as for example, a vertical axis. Likewise, the raised profile may be misaligned with respect to the first axis. The raised profile may extend beyond a planar surface of the master panel. The raised profile may be adapted to be removed substantially from the master panel to form two distinct panels. Each distinct panel may comprise a substantially straight edge. The substantially straight edge may be substantially uniform.

As indicated by block 164, the method 160 may comprise providing a profiled surface disposed between a first die of the press and a second die of the press. As indicated by block 166, the method may comprise providing a recessed surface disposed between a third die of the press and a fourth die of the press. In one embodiment, the recessed surface may be complementary to the profiled surface. The first and second dies together with the third and fourth dies are adapted to form the master panel. The profiled and recessed surfaces together are adapted to form the raised profile of the master panel.

As indicated by block 168, the method 160 may comprise substantially removing the raised profile from the master panel. Removing the raised profile from the master panel forms at least one distinct panel. In one embodiment, removing the raised profile from the master panel forms two distinct panels. Each of the distinct panels thus formed comprises a substantially straight edge. This edge may also be substantially uniform. As indicated by block 169, the method 160 may comprise referencing one of the substantially straight edges when sizing one of the distinct panels.

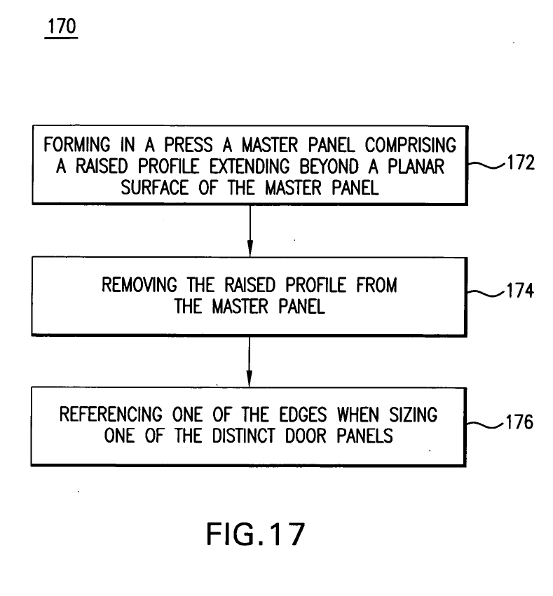

Referring now to FIG. 17, a method 170 according to another embodiment of the present invention is shown. The method 170 may be used to form distinct panels from a master panel according to the present invention. The panels may be similar to that described above. However, the method 170 may be used to form a wide variety of other panels. The panels described above may be referred to in describing the method 170 to aid understanding of the method shown and described.

As indicated by block 172, the method 170 may comprise forming in a press a master panel comprising a raised profile extending beyond a planar surface of the master panel. The raised profile may be formed integrally with the master panel, and may extend substantially along an entire length of the master panel. In one embodiment, the master panel may be misaligned with respect to a first axis, such as a vertical axis. Likewise, the raised profile also may be misaligned with respect to the first axis. As indicated by block 174, the method 170 may comprise removing the raised profile from the master panel. The master panel is separated by removing the raised profile from the master panel. Removing the raised profile from the master panel forms two distinct panels, such as door skin panels. As indicated by block 176, the method 170 may comprise referencing one of the substantially straight edges when sizing one of the distinct panels.

While the present invention has been disclosed with reference to certain embodiments, numerous modifications, alterations, and changes to the described embodiments are possible without departing from the spirit and scope of the present invention, as defined by the appended claims. Accordingly, it is intended that the present invention not be limited to the described embodiments, but that it has the full scope defined by the language of the following claims, and equivalents thereof.

What is claimed is:

1. An apparatus comprising:
a profiled die element disposed between a first die and a second die; and
a recessed die element disposed between a third die and a fourth die, wherein the profiled and recessed die elements together are adapted to form in a pressed master panel a raised profile extending substantially along a length of the pressed master panel.

2. The apparatus of claim 1, wherein the first die and the second die each comprises a male die and wherein the third die and the fourth die each comprises a female die.

3. The apparatus of claim 2, wherein the third die is complementary to the first die and the fourth die is complementary to the second die.

4. The apparatus of claim 3, wherein the first and second dies together with the third and fourth dies are adapted to form the pressed master panel.

5. The apparatus of claim 1, wherein the recessed die element is disposed opposite the profiled die element.

6. The apparatus of claim 5, wherein the recessed die element is complementary to the profiled die element.

7. The apparatus of claim 1, wherein the raised profile formed in the pressed master panel extends beyond a planar surface of the pressed master panel.

8. The apparatus of claim 7, wherein the raised profile is adapted to be removed from the pressed master panel substantially entirely, thereby forming two distinct panels each distinct panel comprising a substantially straight edge.

9. The apparatus of claim 8, wherein the substantially straight edge is used as a reference when sizing the distinct panel.

10. A method comprising:
forming in a press a master panel comprising a raised profile extending beyond a planar surface of the master panel, the raised profile adapted to be removed substantially from the master panel, wherein two distinct panels are formed with each panel comprising a substantially straight edge.

11. The method of claim 10, further comprising:
providing a profiled surface disposed between a first die of the press and a second die of the press; and
providing a recessed surface disposed between a third die of the press and a fourth die of the press, wherein the profiled and recessed surfaces together are adapted to form the raised profile.

12. The method of claim 10, wherein the raised profile extends beyond a planar surface of the master panel.

13. The method of claim 11, wherein the first and second dies together with the third and fourth dies are adapted to form the master panel.

14. The method of claim 11, wherein the recessed surface is complementary to the profiled surface.

15. The method of claim 11, further comprising substantially removing the raised profile from the master panel.

16. The method of claim 15, wherein substantially removing the raised profile from the master panel comprises forming two distinct panels, each distinct panel comprising a substantially straight edge.

17. The method of claim 16, further comprising referencing one of the substantially straight edges when sizing one of the distinct panels.

18. A method comprising:
forming in a press a master panel comprising a raised profile extending beyond a planar surface of the master panel; and
removing the raised profile from the master panel.

19. The method of claim 18, wherein removing the raised profile comprises forming two distinct panels, each of the distinct panels comprising a substantially straight edge.

20. The method of claim 19, further comprising referencing one of the substantially straight edges when sizing one of the distinct panels.

21. A master panel comprising:
a first panel section;
a second panel section opposite the first panel section; and
a raised profile disposed between the first and second panel sections, the raised profile formed in the master panel and joining together the first and second panel sections.

22. The master panel of claim 21, wherein the raised profile extends beyond a first planar surface of the first panel section and a second planar surface of the second panel section.

23. The master panel of claim 22, wherein the raised profile is adapted to be removed substantially entirely from the master panel without removing the first planar surface of the first panel section and the second planar surface of the second panel section.

24. The master panel of claim 21, wherein the raised profile extends substantially along a length of the master panel.

25. A method comprising:
removing a raised profile from a misaligned master panel, thereby forming at least one distinct panel comprising a substantially straight edge; and
sizing the distinct panel by referencing the substantially straight edge.

26. The method of claim 25 further comprising forming the raised profile in the misaligned master panel, wherein the raised profile extends beyond a planar surface of the misaligned master panel.

27. The method of claim 26, wherein the raised profile is formed integrally with the misaligned master panel.

28. The method of claim 25, wherein the raised profile is formed substantially along an entire length of the misaligned master panel.

29. The method of claim 25, wherein the misaligned master panel is misaligned with respect to a first axis.

30. The method of claim 29, wherein the raised profile is misaligned with respect to the first axis.

31. The method of claim 30, wherein the first axis comprises a vertical axis.
